(19) United States
(12) Patent Application Publication
(10) Pub. No.: US 2026/0101157 A1
(43) Pub. Date: Apr. 9, 2026

(54) SYSTEM AND METHOD FOR GENERATING ALERTS OVER A PUSH-TO-TALK NETWORK

(71) Applicants: Raghav PRASHER, Thornhill (CA); Radhika PRASHER, Thornhill (CA)

(72) Inventors: Raghav PRASHER, Thornhill (CA); Radhika PRASHER, Thornhill (CA)

(21) Appl. No.: 18/908,242

(22) Filed: Oct. 7, 2024

(51) Int. Cl. H04W 4/10; G06V 10/70; G06V 20/52; G08B 21/18; H04N 7/18; H04N 23/62

(52) U.S. Cl. CPC H04W 4/10; G06V 10/70; G06V 20/52; H04N 7/181; H04N 23/62; G08B 21/182

(57) ABSTRACT

The present disclosure relates to a computer system for maintaining security of a building. The computer system is connected to at least one push-to-talk radio network and a wireless network. The computer system comprises: network hardware including a push-to-talk radio gateway; and a processor coupled to the push-to-talk radio gateway and the at least one sensor. The computer system further comprises a memory coupled to the processor, the memory storing instructions that, when executed, cause the processor to: receive sensor data from at least one sensor deployed on or within the building; detect, based on the sensor data, an alert condition; generate, in response to the alert condition, a message corresponding to the alert condition; and interface with the push-to-talk radio gateway to transmit the message over the at least one push-to-talk radio network to a push-to-talk device.

### FIELD

The present disclosure is related to a system and method for generating alerts over a push-to-talk (PTT) network or a PTT radio network. In particular, the present disclosure is related to generating automated alerts over a PTT network in response to detected alert conditions in a monitored environment.

### BACKGROUND

PTT radio systems and PTT networks are widely used by public safety, military, transportation, and industrial entities that require instant voice communication capabilities. PTT devices connected to a PTT network or PTT radio network can be in either a reception mode or a transmission mode. When in the reception mode, the PTT device can only receive transmission or broadcasts over the PTT network from other PTT devices connected to the PTT network. When in the transmission mode, the PTT device can transmit or broadcast messages over the PTT network to other PTT devices connected to the PTT network.

Communication using PTT networks and PTT devices has multiple benefits or advantages. For example, PTT communication is effective for instantly transmitting a message or an audio message to an individual or a group. PTT communication is also high reliable and secure. Hence, PTT communication is a popular mode of communication for security teams or security personnel of buildings or facilities.

However, existing PTT systems lack an automated way to, in response to threats, risks, and dangers, such as security threats, rapidly disseminate alerts across a PTT network to many PTT devices or users at once without user intervention.

### BRIEF DESCRIPTION OF THE DRAWINGS

Reference will now be made, by way of example, to the accompanying drawings which show example embodiments of the present application, and in which:

FIG. 1 is a diagram illustrating an example network environment for generating automated alert over a PTT network with respect to a monitored environment;

FIG. 1A is a diagram illustrating an example security system for generating automated security alerts over a PTT network;

FIG. 2 is a block diagram illustrating an example PTT device;

FIG. 3 is a block diagram illustrating an example computing system for generating automated security alerts over a PTT network;

FIG. 4 shows in flowchart form, a simplified method allowing for generation of automated security alerts over a PTT network;

FIG. 5 is a simplified diagram illustrating a computer system connected to a first group of PTT devices and a second group of PTT devices via a first and second PTT network respectively;

FIG. 6 shows in flowchart form, a simplified method allowing for generation of automate security alerts over multiple PTT networks; and

FIG. 7 shows in flowchart form, a simplified method, allowing for a computer system to respond to reply messages over a PTT network and trigger security actions.

Similar reference numerals may have been used in different figures to denote similar components.

### DESCRIPTION OF EXAMPLE EMBODIMENTS

In an aspect, the present disclosure describes a computer system for maintaining security of a building. The computer system is connected to at least one push-to-talk radio network and a wireless network. The computer system comprises: network hardware including a push-to-talk radio gateway; and a processor coupled to the push-to-talk radio gateway and the at least one sensor. The computer system further comprises a memory coupled to the processor, the memory storing instructions that, when executed, cause the processor to: receive sensor data from at least one sensor deployed on or within the building; detect, based on the sensor data, an alert condition; generate, in response to the alert condition, a message corresponding to the alert condition; and interface with the push-to-talk radio gateway to transmit the message over the at least one push-to-talk radio network to a push-to-talk device.

In some implementations, the at least one sensor includes a camera and the alert condition is detected based, at least in part, on identifying a threat depicted in one or more images generated by the camera.

In some implementations, the computer system is configured to detect the alert condition by using artificial intelligence to analyze the sensor data.

In some implementations, the computer system is configured to use a large language model to generate the message.

In some implementations, the computer system is further configured to: determine a priority level of the alert condition; determine that the priority level exceeds a threshold; and transmit via the wireless network, prior to interfacing with the push-to-talk radio gateway, in response to determining that the priority level exceeds the threshold, mode instructions to the push-to-talk device, the mode instructions causing the push-to-talk device to be in a reception mode.

In some implementations, the at least one push-to-talk radio network includes multiple push-to-talk networks; and the push-to-talk device is connected to a first push-to-talk network of the multiple push-to-talk networks. Further, the instructions further configure the computer system to: determine, prior to interfacing with the push-to-talk radio gateway, that the alert condition is relevant to a user of the push-to-talk device; and select the first push-to-talk network in response to determining that the alert condition is relevant to the user. Further, interfacing with the push-to-talk radio gateway to transmit the message over the at least one push-to-talk radio network further comprises transmitting the message over the first push-to-talk network.

In some implementations, the at least one sensor includes a wearable sensor situated on a person.

In some implementations, instructions further configure the computer system to: receive a reply from the push-to-talk device; identify, in the reply, a voice signature; determine that an authorized user is an owner of the voice signature; identify, in the reply, a command to initiate a security action; and trigger, in response to identifying the command to initiate the security action, the security action.

In some implementations the security action includes manipulating a security camera.

In some implementations, the instructions further configure the computer system to: identify, in the reply, a query; determine, in response to the query, an answer to the query based on the sensor data; generate, in response to determining the answer, a second message corresponding to the answer; and transmit the second message to the push-to-talk device.

In some implementations, the sensor data includes video data, and the instructions further configure the processor to transmit a sample of the video data selected to represent the alert condition to the push-to-talk device.

In some implementations, the instructions further configure the computer system to track, using the at least one sensor, one or more assets within the building, and the alert condition corresponds to one of the one or more assets exiting an authorized zone.

In some implementations, the instructions further configure the computer system to: maintain an inventory record; and track, using the at least one sensor, one or more assets within the building, and the alert condition corresponds to an inconsistency of the inventory record and the one or more assets.

In some implementations, the instructions further configure the computer system to track, using the at least one sensor, one or more assets within the building, and the alert condition corresponds to an unauthorized translation of one of the one or more assets.

In some implementations, the instructions further configure the computer system to obtain point-of-sale data from a point-of-sale system, and the alert condition is an anomaly in the point-of-sale data.

In another aspect, the present disclosure discloses a computer-implemented method for maintaining security of a building. The method comprises: receiving sensor data from at least one sensor deployed on or within the building; detecting, based on the sensor data, an alert condition; generating, in response to the alert condition, a message corresponding to the alert condition; and interfacing with a push-to-talk radio gateway to transmit the message over at least one push-to-talk radio network to a push-to-talk device.

In some implementations, the method further comprises: determining a priority level of the alert condition; determining that the priority level exceeds a threshold; and transmitting via a wireless network, prior to interfacing with the push-to-talk radio gateway, in response to determining that the priority level exceeds the threshold, mode instructions to the push-to-talk device, the mode instructions causing the push-to-talk device to be in a reception mode.

In some implementations, the at least one push-to-talk radio network includes multiple push-to-talk networks and the push-to-talk device is connected to a first push-to-talk network of the multiple push-to-talk networks. The method further comprises: determining, prior to interfacing with the push-to-talk radio gateway, that the alert condition is relevant to a user of the push-to-talk device; and selecting the first push-to-talk network in response to determining that the alert condition is relevant to the user. Further, interfacing with the push-to-talk radio gateway to transmit the message over the at least one push-to-talk radio network further comprises transmitting the message over the first push-to-talk network.

In some implementations, the method further comprises: receiving a reply from the push-to-talk device; identifying, in the reply, a voice signature; determining that an authorized user is an owner of the voice signature; identifying, in the reply, a command to initiate a security action; and triggering, in response to identifying the command to initiate the security action, the security action.

In some implementations, the method further comprises: identifying, in the reply, a query; determining, in response to the query, an answer to the query based on the sensor data; generating, in response to determining the answer, a second message corresponding to the answer; and transmitting the second message to the push-to-talk device.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrases “at least one of . . . and . . . ” is intended to cover any one or more of the listed elements, including any one of the listed elements alone, any sub-combination, or all of the elements, without necessarily excluding any additional elements, and without necessarily requiring all of the elements. Similarly, the phrase “at least one of . . . or . . . ” is also intended to cover any one or more of the listed elements, including any one of the listed elements alone, any sub-combination, or all of the elements, without necessarily excluding any additional elements, and without necessarily requiring all of the elements.

The present disclosure relates to a monitoring system used to monitor a monitored environment. In some embodiments, the monitored environment may be a building and the monitoring system may be, or part of, a building security system. For example, the building security system may comprise elements such as security cameras, doors, lights, and alarms. A computer system may interface with these elements to protect, for example, assets or people inside the building. For example, in response to detecting an armed person in the building, the computer system, at the direction of security personnel for example, lock select doors of the building and sound an alarm or siren. In another example, the computer system may cause the security cameras of a building to track an asset that is being moved without authorization.

In another embodiment, the monitored environment may be a laboratory containing hazardous or toxic materials or chemicals. In another embodiment, the monitored environment may be a food preparation environment such as a kitchen of a restaurant. In these embodiments, a computer system may interface with monitoring or surveillance elements, such as cameras, to identify health or safety risks. The computer system may also notify personnel related to the monitored environment of the identified health or safety risks. For example, in response to detecting improperly disposed toxic waste in a laboratory, the computer system may instruct a onsite laboratory technician to dispose the toxic waste properly. In another example, in response to detecting the use of a contaminated knife in preparing a bagel sandwich, the computer system may instruct onsite kitchen staff to halt preparation of the bagel sandwich, dispose the prepared or partially prepared bagel sandwich, and clean or sanitize the knife.

The monitoring system may send and receive data from a computer system. In some embodiments, the computer system may be coupled to or operatively coupled to the monitoring system. Additionally or alternatively, the computer system may be connected to the monitoring system over a wireless network. The computer system may also be connected to PTT devices over a PTT network. PTT is a mode of communication that uses a switch to switch from a reception mode to a transmission mode. Multiple devices may communicate using PTT, however, only one device may transmit at one time under PTT. A walkie talkie is an example device that uses PTT. PTT networks may be established over, for example, radio networks and cellular networks such as WiFi and 5G networks to connect multiple devices. These devices connect via a PTT network may be called PTT devices. PTT devices allow for fast and easy communication between team members. For example, if a security guard of a building observes a security threat such as unauthorized entry into a zone of the building, the security guard may communicate the observation to another security guard. When communicating with the another security guard, switching a PTT device from the reception mode to the transmission mode offers quick communication compared to, for example, dialing a phone to communicate with the another guard. Hence, security personnel of the building may use PTT devices to communicate with each other.

The present application implements a system and method that allows the computer system to automatically generate alerts or security alerts over a PTT network to onsite operators or personnel such as security personnel, kitchen staff, laboratory technicians, and custodians. The system and method may also allow the computer system or the monitoring system to respond to commands received from the onsite operators or personnel from their PTT devices.

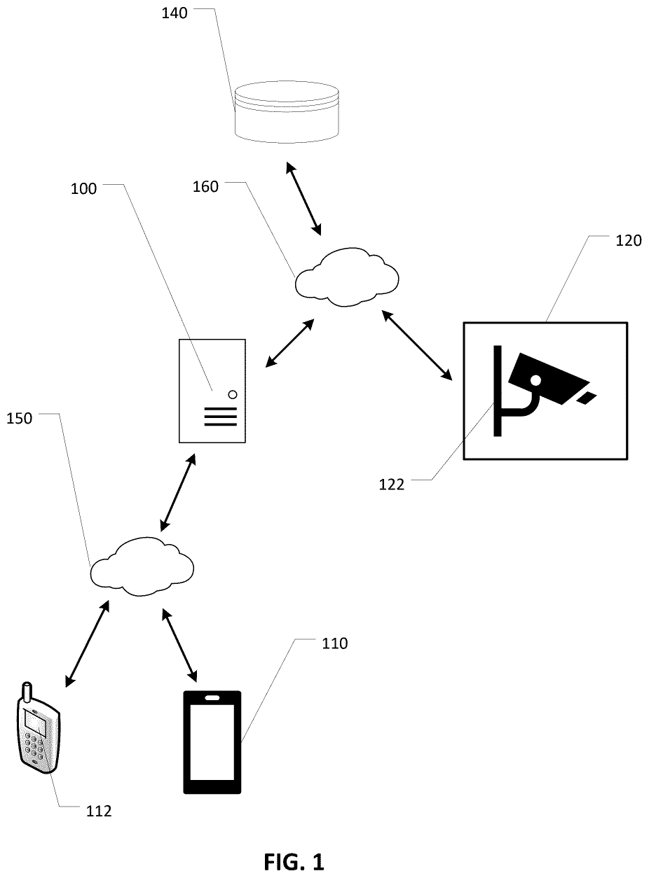

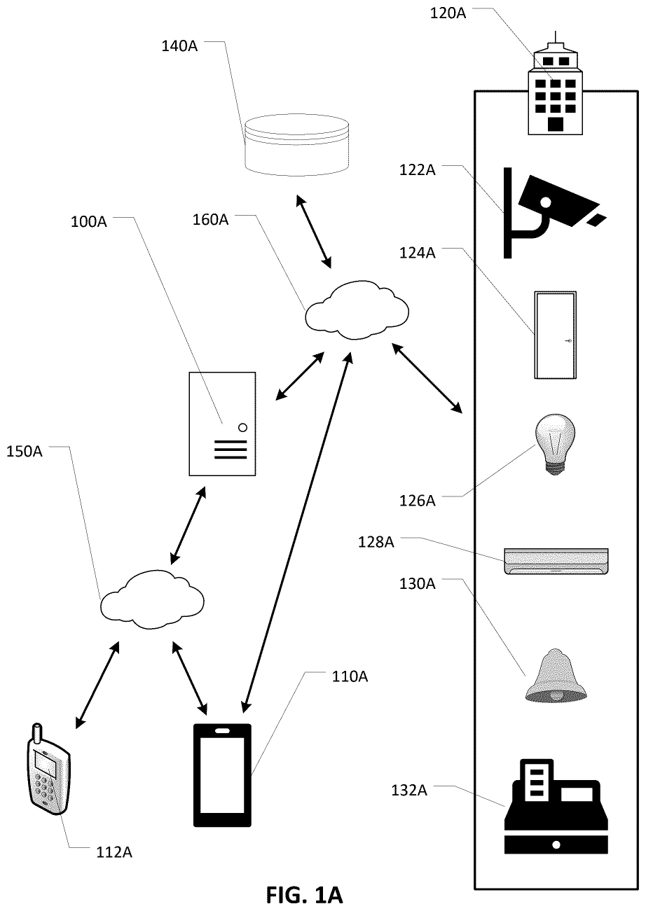

References is made to FIG. 1, which illustrates an example network environment for generating automated alert over a PTT network with respect to a monitored environment. In some embodiments, the monitored environment may be a building. In some embodiments, the monitored environment may be a food preparation environment such as a kitchen. In some embodiments, the monitored environment may be a laboratory containing hazardous or toxic materials or chemicals. As shown in FIG. 1, the network environment may include a computer system 100 (depicted as a server), PTT devices 110 and 112, a monitoring system 120, a database 140, at least one PTT network 150 connecting the computer system 100 and the PTT devices 110 and 112, and a wireless network 160 connecting the computer system 100, the PTT device 110, the monitoring system 120, and the database 140. The monitoring system 120 may include a sensor system 122 (depicted as a security camera).

The sensor system 122 may include cameras, audio recorders, heat sensors, temperatures sensors, moisture sensors, pressure sensors, smoke sensors, air quality sensors, chemical sensors, light sensors, touch sensors, motion sensors, electronic article surveillance (EAS) sensors, radio frequency identification (RFID) readers, and Bluetooth low energy (BLE) gateways. The computer system 100 may detect threats such as health hazards, safety risks, and security threats based on data obtained from the sensor system 122. For example, the computer system 100 may detect, based on data received from the cameras of the sensor system 122, that a contaminated has been used to prepare a bagel sandwich in a kitchen. In another example, the computer system 100 may detect, based on data received from the heat sensors of the sensor system 122, that the temperature of a room storing temperature-sensitive assets, such as explosives, is approaching a dangerous temperature. The computer system 100 may also manipulate the sensor system 122. For example, in response to detecting an attempted theft or an armed individual, the computer system 100 may cause the cameras of the sensor system 122 to follow the would-be thief or armed individual. Additionally or alternatively, the computer system 100 may cause one of the cameras of the sensor system 122 to zoom in on the face of the would-be thief or armed individual.

The sensor system 122 may also comprise wearable sensors. For example, a laboratory technician may have a camera strapped to their chest, thereby allowing the computer system 100 to collect video data or visual information corresponding to the observations of the laboratory technician. This collected video data or visual information may allow the computer system 100 to determine that the laboratory technician is disposing toxic waste properly. In another example, kitchen staff may have a camera strapped to their chests. The computer system 100 may determine from data collected from their chests that the kitchen staff are following food safety guidelines and protocols correctly.

In some embodiments, the monitoring system 120 may have a monitoring computer system that communicates data from the sensor system 122 to the computer system 100 via the wireless network 160. In other embodiments, the sensor system 122 may communicate directly with the computer system 100 via the wireless network 160. In other embodiments, the monitoring computer system may be or include the computer system 100. In some embodiments, the computer system 100 may be coupled to the sensor system 122 or coupled to sensor elements of the sensor system 122.

In some embodiments, the database 140 may store data relating to safety guidelines or protocols. For example, the database 140 may store data relating to the proper or safe way to dispose hazardous or toxic waste or materials. In another example, the database 140 may store data corresponding to food safety guidelines and protocols. Additionally or alternatively, the database 140 may store a communication history of messages sent and received over the at least one PTT network 150. The communication history may include alerts generated by the computer system 100. In some embodiments, the computer system 100 may detect a threat by comparing data received from the sensor system 122 with safety guidelines or protocols stored in the database 140. The computer system 100 may use artificial intelligence, machine learning, video analytics, or visual processing to compare the data received from the sensor system 122 with the safety guidelines or protocols. In some embodiments, the database 140 may be part of the computer system 100.

The wireless network 160 connects systems of the monitoring system 120 with the computer system 100 and the database 140. The wireless network 160 may be a cellular network such as a WiFi network, a local area network (LAN), a wide area network (WAN), a 5G network, or a combination thereof.

The at least one PTT network 150 may connect the computer system 100 and the PTT devices 110 and 112. The PTT devices 110 and 112 may be any devices that support PTT communication or PTT radio communication over a PTT network including a radio, a cellular phone, a smartphone, and a desktop computer. Upon detecting a security threat, the computer system 100 may send an alert to the PTT devices 110 and 112 over the at least one PTT network 150. For example, upon detecting improperly disposed ammonia in a laboratory, the computer system 100 may send an audio alert saying “improperly disposed ammonia detected on Counter 5 of Laboratory 2” to the PTT device 110 and 112. In another example, the computer system 100 may send a text alert saying “Improperly disposed ammonia detected on Counter 5 of Laboratory 2.” In another example, upon detecting use of a contaminated kitchen knife in preparing a bagel sandwich, the computer system 100 may send an audio alert saying “The knife you used has not been sanitized according to food safety guidelines. Please dispose the bagel sandwich you are preparing and send knife for sanitation.” Users or device holders may also use the PTT devices 110 and 112 to send messages to the computer system 100. For example, in response to receiving the message “The knife you used has not been sanitized according to food safety guidelines. Please dispose the bagel sandwich you are preparing and send knife for sanitation,” a cook may speak into a mic of the PTT device 110 saying “Understood.” The computer device 100 may also send image or video data to the PTT device 110 and 112 over the at least one PTT network 150. For example, in response to detecting improperly disposed ammonia in a laboratory, the computer system may send an image showing the improperly disposed ammonia to the PTT device 110.

While FIG. 1 illustrates the PTT device 110 and 112 as handheld devices, in some embodiments, the PTT device 110 or 112 may be a wearable device. For example, the PTT device 110 may be an earpiece or headset worn by kitchen staff.

In some embodiments, the at least one PTT network 150 may be multiple PTT networks. For example, the PTT network connecting the computer system 100 to the PTT device 110 may be different from the PTT network connecting the computer system 100 to the PTT device 112. In some implementations, the PTT device 110 may be held by a first cook and the PTT device 112 may be held by a second cook in a kitchen of a restaurant. In this implementation, upon detecting that the first cook has breached a food safety guideline or protocol, the computer system 100 may transmit a message to a PTT network specific to the PTT device 110. In another implementation, the PTT device 110 may be assigned to or associated with a first laboratory and the PTT device 112 may be assigned to or associated with a second laboratory. In this implementation, the computer system 100 may send an alert related to the first laboratory only to the PTT device 110 over a PTT network or PTT radio network specific to the PTT device 110.

References is now made to FIG. 1A, which illustrates an example security system for generating automated security alerts over a PTT network or PTT radio network. FIG. 1A may be considered to illustrate an embodiment more specific than FIG. 1. That is, the embodiments in FIGS. 1 and 1A may not be mutually exclusive. As shown in FIG. 1A, the security system may include a computer system 100A (depicted as a server), PTT devices 110A and 112A, a building 120A, a database 140A, at least one PTT network 150A connecting the computer system 100A and the PTT devices 110A and 112A, and a wireless network 160A connecting the computer system 100A, the PTT device 110A, the building 120A, and the database 140A. The building 120A may include a sensor system 122A (depicted as a security camera), a door system 124A, a lighting system 126A, a heat, ventilation, and air conditioning (HVAC) system 128A, an alarm system 130A, and a point-of-sale (POS) device system 132A.

The sensor system 122A may include cameras, audio recorders, heat sensors, temperatures sensors, moisture sensors, pressure sensors, smoke sensors, air quality sensors, chemical sensors, light sensors, touch sensors, motion sensors, electronic article surveillance (EAS) sensors, radio frequency identification (RFID) readers, and Bluetooth low energy (BLE) gateways. The computer system 100A may detect security threats based on data obtained from the sensor system 122A. For example, the computer system 100A may detect an attempted theft or an armed individual from the cameras of the sensor system 122A. In another example, the computer system 100A may detect, based on data received from the heat sensors of the sensor system 122A, that the temperature of a room storing temperature-sensitive assets, such as explosives, is approaching a dangerous temperature. Computer system 100A may also manipulate the sensor system 122A. For example, in response to detecting an attempted theft or an armed individual, the computer system 100A may cause the cameras of the sensor system 122A to follow the would-be thief or armed individual. Additionally or alternatively, the computer system 100A may cause one of the cameras of the sensor system 122A to zoom in on the face of the would-be thief or armed individual.

The sensor system 122A may also comprise wearable sensors situated on security personnel. For example, security personnel may have a camera strapped to their chest, thereby allowing the computer system 100A to collect video data or visual information corresponding to the observations of security personnel of the building 120A.

The computer system 100A may affect the door system 124A in response to detected security threats. For example, in the event that the computer system 100A detects an armed individual in the building, the computer system 100A may cause select doors of the building 120A to lock, thereby trapping the armed individual. Additionally or alternatively, the computer system 100A may cause select doors to open, thereby allowing occupants of the building 120A to evacuate quickly. Additionally or alternatively, the computer system 100A may cause another set of select doors to open, thereby allowing security personnel of the building 120A to reach the armed individual quickly.

The computer system 100A may affect the lighting system 126A in response to detected security threats. For example, in the event that the computer system 100A detects attempted theft, the computer system 100A may cause select lights to turn off, thereby stalling the would-be thief. Additionally or alternatively, the computer system 100A may light a path, via emergency lights for example, for security personnel to follow and reach the would-be thief quickly.

The computer system 100A may affect the HVAC system 128A in response to detected security threats. For example, in the event that the computer system 100A detects a temperature abnormality in a room containing temperature sensitive-assets, the computer system 100A may cause the HVAC system 128A to adjust to temperature in that room. In another example, in the event that the computer system 100A detects an unacceptable level of a toxic chemical in the air, the computer system 100A may cause the HVAC system 128A to clean the air at a faster rate.

The alarm system 130A may be triggered by an occupant of the building 120A or security personnel of the building 120A. For example, security personnel may trigger an alarm upon observing an armed individual. Upon triggering an alarm, the alarm system 130A may notify the computer system 100A that an alarm was triggered via the wireless network 160A. The computer system 100A may also trigger an alarm or the alarm system 130A upon detecting a threat. For example, upon detecting an attempted theft or armed individual, the computer system 100A may trigger the alarm system 130A.

In some embodiments, the alarm system 130A may include a different alarm for different situations. For example, an alarm triggered in response to detecting an unauthorized person in a restricted zone may be different from an alarm triggered in response to detecting a toxic chemical level exceeding a certain threshold.

The POS device system 132A may include POS devices in the building 120A such as cash registers or credit card payment devices. The computer system 100A may detect security threats based on data obtained from the POS device system 132A. For example, the computer system 100A may detect that POS records and inventory records fail to align, thereby indicating a theft. In some embodiments, the computer system 100A may affect the POS device system 132A. For example, in the event that the computer system 100A determines that an employee has been stealing funds, the computer system 100A may revoke the authorization of that employee to use POS devices in the POS device system 132A.

The sensor system 122A, the door system 124A, the lighting system 126A, the HVAC system 128A, the alarm system 130A, and the POS device system 132A may not be mutually exclusive. For example, some of the sensors in the sensor system 122A, such as temperature sensors or air quality sensors may be part of the HVAC system 128A.

In some embodiments, the building 120A may have a building computer system that communicates data from the sensor system 122A, the door system 124A, the lighting system 126A, the alarm system 130A, and the POS device system 132A to the computer system 100A via the wireless network 160A. In other embodiments, some or all of the sensor system 122A, the door system 124A, the lighting system 126A, the alarm system 130A, and the POS device system 132A may communicate directly with the computer system 100A via the wireless network 160A. In other embodiments, the building computer system may be or include the computer system 100A.

In some embodiments, the database 140A may store the POS data from POS device system 132A. Additionally or alternatively, the database 140A may store inventory records. Additionally or alternatively, the database 140A may store a communication history of messages sent and received over the at least one PTT network 150A. The communication history may include alerts generated by the computer system 100A. In some embodiments, the computer system 100A may detect a security threat from an anomaly when comparing inventory data and POS data stored in the database 140A. In some embodiments, the database 140A may be part of the computer system 100A.

The wireless network 160A connects systems of the building 120A with the computer system 100A and the database 140A. The wireless network 160A may be a cellular network such as a WiFi network, a local area network (LAN), a wide area network (WAN), a 5G network, or a combination thereof.

The at least one PTT network 150A may connect the computer system 100A and the PTT devices 110A and 112A. The PTT devices 110A and 112A may be any devices that support PTT communication or PTT radio communication over a PTT network including a radio, a cellular phone, a smartphone, and a desktop computer. Upon detecting a security threat, the computer system 100A may send an alert to the PTT devices 110A and 112A over the at least one PTT network 150A. For example, upon detecting an armed individual in a particular location of a grocery store, the computer system 100A may send an audio alert saying “armed individual spotted in aisle 4” to the PTT device 110A and 112A. In another example, the computer system 100A may send a text alert saying “Armed individual spotted in aisle 4.” Security personnel may also use the PTT devices 110A and 112A to send messages to the computer system 100A. For example, in response to receiving the message “Armed individual spotted in aisle 4,” a security personnel may speak into a mic of the PTT device 110A saying “What does the armed individual look like?” The computer device 100A may also send video to the PTT device 110A and 112A over the at least one PTT network 150A. For example, in response to detecting a security threat from a security camera of the sensor system 122A, the computer system 100A may transmit a sample video clip depicting the security threat to the PTT device 110A over the at least one PTT network 150A.

In some embodiments, the at least one PTT network 150A may be multiple PTT networks. For example, the PTT network connecting the computer system 100A to the PTT device 110A may be different from the PTT network connecting the computer system 100A to the PTT device 112A. In some implementations, PTT device 110A and PTT device 112A may be held by security personnel in different security groups. For example, if the building 120A has multiple zones or sections such as a Zone 1 and a Zone 2, the PTT device 110A may be held by security guard in the Zone 1 and the PTT device 112A may be held by a security guard in the Zone 2. In this implementation, the computer system 100A may send a security alert related to the Zone 1 only to the PTT device 110A over a PTT network or PTT radio network specific to the PTT device 110A.

In some embodiments, the PTT device 110A may be connected to the wireless network 160A. For example, the PTT device 110A may have a camera that can be used as a security camera. In order to save bandwidth for emergencies or security alerts on the at least one PTT network 150A, video captured by the PTT device 110A in its function as a security camera may be communicated to the computer system 100A over the wireless network 160A. In other embodiments, the PTT device 110A may track its own location via, for example, global positioning system (GPS), and transmit its location to the computer system 100A over the wireless network 160A. The computer system 100A may determine location of a security personnel from the received transmitted location of the PTT device 110A. In other embodiments, in response to security threats, security personnel may trigger a response directly from their PTT device. For example, if the PTT device 110A is a smartphone, the security personnel using the PTT device 110A may directly trigger an alarm from the PTT device 110A by sending alarm trigger instructions to the alarm system 130A via the wireless network 160A.

In some embodiments, the computer system 100A may disconnect the PTT devices 110A or 112A from the at least one PTT network 150A. For example, in the event that the computer system 100A detects, via a non-matching voice signature, that an unauthorized user is using the PTT device 110A, computer system 100A may disconnect the PTT device 110A. In other embodiments, the computer system 100A may disconnect the PTT device 110A from the wireless network 160A.

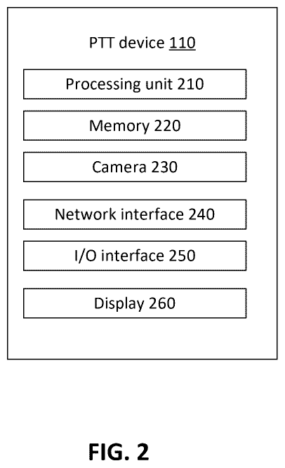

Reference is made to FIG. 2, which illustrates an example PTT device 110 (also seen in FIG. 1). The description of the PTT device 110 may also be applicable to the PTT device 112, 110A, or 112A (see FIGS. 1 and 1A). The PTT device 110 may be any electronic device capable of displaying a user interface. Examples of suitable electronic devices include mobile devices (e.g., smartphones, tablets, laptops, etc.), among others. Example components of the PTT device 110 are now described, which are not intended to be limiting. It should be understood that there may be different implementations of the PTT device 110.

The PTT device 110 includes at least one processing unit 210 such as a processor, microprocessor, an application-specific integrated circuit (ASIC), a field-programmable gate array (FGPA), a dedicated logic circuitry, a graphics processing unit (GPU), a central processing unit (CPU), a dedicated artificial intelligence processor unit, or combinations thereof. The processing unit 210 may execute PTT applications installed on the PTT device 110.

The PTT device 110 includes at least one memory 220, which may include a volatile or non-volatile memory (e.g., a flash memory, a random access memory (RAM), and/or a read-only memory (ROM)). The memory 220 may store instructions for execution by the processing unit 210.

The PTT device 110 may include a camera 230. Users of the PTT device 110 such as security personnel, laboratory technicians, or kitchen staff, may use the camera 230 to capture images or video to send to a computer system used to monitor an environment.

The PTT device 110 includes at least one network interface 240 for wired or wireless communication with an external system or network (e.g., a PTT network, cellular, an intranet, the Internet, a P2P network, a WAN, a LAN), and in particular, for communication with a computer system monitoring an environment such as the computer system 100 or 100A (see FIGS. 1 and 1A). In some embodiments, the PTT device 110 may be able to wirelessly communicate with the computer system over separate networks. For example, the PTT device 110 may communicate with the computer system 100 over at least one PTT network 150 or a wireless network 160 (see FIG. 1). In some embodiments, the PTT device 110 may operate in a transmission mode or a reception mode. When in transmission mode, the PTT device 110 may transmit messages or data over the PTT network. When in reception mode, the PTT device 110 may receive messages or data over the PTT network. In some embodiments, the PTT device 110 may only transmit messages or data over the PTT network when in transmission mode.

In some embodiments, messages transmitted or received over the PTT network may have an associated priority level. In the event that, the PTT device 110 receives multiple messages over the PTT network, the PTT device 110 may cause the message with the higher associated priority level to override the message with the lower priority level. That is, PTT device 110 receives the message with the higher priority level.

The PTT device 110 also includes at least one input/output (I/O) interface 250, which interfaces with input and output devices. In some examples, the same component may serve as both an input and output device (e.g., a display 260 may be a touch-sensitive display). The PTT device 110 may include other input devices (e.g., buttons, microphone, touchscreen, keyboard, etc.) and other output devices (e.g., speaker, vibration unit, etc.).

The PTT device 110 may also include a display 260. In some embodiments, if a PTT application is running on the PTT device 110, the display 260 may show the words “transmission” when the PTT device 110 is in transmission mode. Likewise, display 260 may show the words “reception” when the PTT device 110 is in reception mode. In some embodiments, a PTT application running on the PTT device 110 may cause display 260 to show a switch button. Pressing the switch button may cause the PTT device 110 to switch from reception mode to transmission mode or vice versa. Additionally or alternatively, a PTT application running on PTT device 110 may cause a PTT button on the display 260 wherein pressing the PTT button causes the PTT device 110 to enter transmission mode whereas the PTT device 110 would otherwise be in a default reception mode.

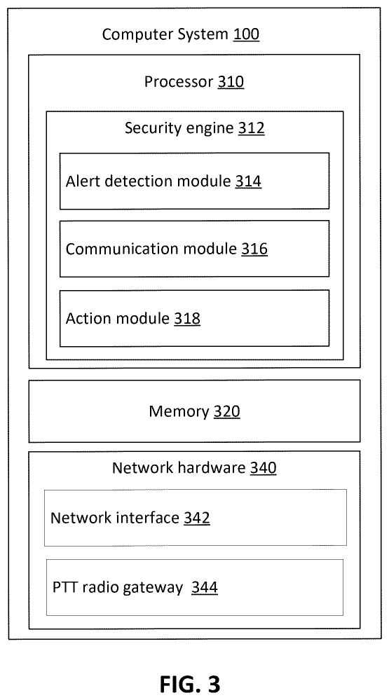

Reference is made to FIG. 3 which illustrates an example computer system 100 (see FIG. 1) for generating automated security alerts, related to a monitored environment over a PTT network. The description of the computer system 100 with respect to FIG. 3 may also be applicable to the computer system 100A (see FIG. 1A). As shown in FIG. 3, the computer system 100 may include at least one processor 310 and a memory 320. The at least one processor 310 may be a central processing unit, a microprocessor, a signal processor, an application-specific integrated circuit (ASIC), a field-programmable gate array (FGPA), a dedicated logic circuity, a dedicated artificial intelligence processor unit, a graphic processing unit (GPU), a tensor processing unit (TPU), a neural processing unit (NPU), a hardware accelerator, or combinations thereof. The memory 320 may include volatile or non-volatile memory (e.g. a flash memory, a random access memory, (RAM), and/or a read-only memory (ROM)). The memory 320 may be considered a computer-readable storage medium storing computer-executable instructions or a memory storing computer-executable instructions. The memory 320 may store instructions for execution by the at least one processor 310. The memory 320 may be coupled to the at least one processor 310.

Although FIG. 3 shows a single instance of each component, there may be multiple instances of each component in the computer system 100. Further, although the computer system 100 is illustrates as a single block, the computer system 100 may be a single physical machine or device (e.g. implemented as a single computing device, such as a single workstation, single end user device, single server, etc.), or may comprise a plurality of physical machines or devices (e.g., implemented as a server cluster). For example, the computer system 100 may represent a group of servers or cloud computing platform providing a virtualized pool of computing resources (e.g., a virtual machine, a virtual server).

The memory 320 may contain security software, programming, or computer-executable instructions which, when executed by the processor 310, perform various security functions. In the embodiment illustrated in FIG. 3, the processor 310 has a security engine 312 to execute security software. The security engine 312 may be in communication with the memory 320. The security engine 312 is shown including an alert detection module 314, a communication module 316, and an action module 318.

The alert detection module 314 allows the processor 310 to detect security threats or alert conditions. The processor 310 may detect alert conditions by analyzing data obtained from a sensor system such as the sensor system 122 or 122A, a door system such as the door system 124A, a lighting system such as the lighting system 126A, an HVAC system such as the HVAC system 128A, an alarm system such the alarm system 130A, a POS system such as the POS device system 132A, or a database such as the database 140 or 140A (see FIGS. 1 and 1A).

Data obtained from the sensor system may include image and video data from cameras, audio data from audio recorders, temperature or heat data from heat sensors or temperature sensors, moisture data from moisture sensors, pressure data from pressure or touch sensors, lighting data from light sensors, chemical data from smoke sensors or other chemical sensors such as air quality sensors, motion data from motion sensors, EAS data from EAS sensors, RFID data from RFID readers, and BLE data from BLE gateways. Data obtained from the door system may relate to the states of the doors of the building. For example, each door in the building may be in one of four states: open & idle, open & opening, open & closing, and closed. Data obtained from the lighting system may relate to the states of the lights in the building. For example, each light in the building may have a stated defined by a numeric value representing its brightness. In another example, each light in the building may have a state defined by a first value representing brightness and a second value representing color. Data obtained from the HVAC system may relate to temperature and air quality of each room or section of the building. Data obtained from the alarm system may relate to the states of alarms in the building. For example, each alarm in the building may be in a state defined by an activation variable (e.g. 0 for off and 1 for on), a defectiveness variable (e.g. 0 or not defective, 1 for detective such as in the situation when the alarm should be on but is not), and a trigger source variable (corresponding to how the alarm was turned on if it is on). Data obtained from the POS device system may relate to sales that have occurred in the building such as user ID of a POS device in relation to a particular sale of a product. Data obtained from the database may include inventory data.

In some embodiment, the processor 310 may detect alert conditions using video analytics or image analysis on images or video received from cameras. For example, the processor 310 may use video analytics to detect that a vehicle entering a restricted zone does not have an authorized license number. In another example, the processor 310 may use facial recognition technology on an image to determine that an unauthorized person is carrying a firearm.

In some embodiments, the processor 310 may detect alert conditions using an EAS system or sensor. For example, the processor 310 may receive from an EAS sensor indicating that an EAS-tagged item has been removed from a location without deactivation of the EAS tag. More generally, the processor 310 may detect unauthorized translations or unauthorized locations of tracked assets via the use of EAS technology.

In some embodiments, the processor 310 may detect alert conditions based on data obtained from RFID readers. For example, the processor 310 may receive data from an RFID reader indicating that a RFID-tagged item is not present in an expected location for that item. More generally, the processor 310 may detect unauthorized translations or unauthorized location of tracked assets via the use of RFID technology.

In some embodiments, the processor 310 may detect alert conditions based on data obtained from BLE gateways. For example, the processor 310 may receive data from a BLE gateway indicating that a BLE-tagged item has been removed from the premises of a store. More generally, the processor 310 may detect unauthorized translations or unauthorized locations of tracked assets via the use of BLE and geofencing technology.

In some embodiments, the processor 310 may detect alert conditions based on data obtained from the POS device system. For example, the processor 310 may detect that inventory levels are inconsistent with sales data. In another example, the processor 310 may detect an anomaly in sales data such as voiding of transactions and no-sale events.

In some embodiments, the processor 310 may analyze obtained data in real-time. In other embodiments, the processor 310 may analyze past data that has been stored in, for example, the database. For example, the processor 310 may detect alert conditions by comparing data relating to the building in “safe” periods of the past to current data.

In some embodiments, the processor 310 may detect alert conditions based on pre-defined conditions or commands. For example, the processor 310 may determine that an EAS sensor detecting removal of a tagged item without deactivation, by itself, is a security threat or an alert condition. In another example, the processor 310 may determine that an inconsistency between inventory and sales data that exceeds a defined threshold is an alert condition.

In some embodiments, the processor 310 may use artificial intelligence or machine learning algorithms to detect alert conditions. For example, the processor 310 may detect a threat from camera footage by analyzing the images from the camera using machine learning techniques. The processor 310 may also, using machine learning, detect features of the threat. For example, in the event that the processor 310 detects an unauthorized person carrying a firearm, the processor 310 may also detect that the firearm holder is wearing a shirt of a particular color and a particular brand, is of a particular sex, is of a particular height, has a particular movement pattern (e.g. a limp), has a particular hair color, etc. In another example, machine learning may be used to detect behavior predictive of a security threat from camera footage. For example, the processor 310 may detect abnormal or suspicious loitering of an individual. In another example, machine learning may be used to detect anomalies in POS data.

In some embodiments, the processor 310 may detect the location of the alert condition. For example, the processor 310 may receive RFID data indicating that an item with an RFID is in an unauthorized location or zone for that item. In another embodiment, the processor 310 may detect location using artificial intelligence such as machine learning or video analytics. For example, the processor 310 may detect from images from a camera that a theft is occurring at a particular aisle in a retail store.

The communication module 316 allows the processor 310 to communicate with operators, staff, or personnel related to the monitored environment. Examples of operators, staff, and personnel include kitchen staff of a monitored kitchen, laboratory technicians of a monitored laboratory, and security personnel of a monitored building. In some embodiments, the processor 310 may generate messages corresponding to detected security threats or alert conditions. For example, in response to detecting an unauthorized person with a firearm in, for example, aisle 4 of a store, the processor 310 may generate the message “Firearm carrying person detected in Aisle 4.” In another example, in response to detecting that an RFID-tagged item is in an incorrect Area 1 instead of a correct Area 2, the processor 310 may generate the message “RFID: XXXXXXXXX (box of medications) found in Area 1 instead of Area 2.”

In some embodiments, the processor 310 may generate pre-defined messages. For example, the message “RFID: XXXXXXXXX (box of medications) found in Area 1 instead of Area 2” may be a pre-defined message for the appropriate situation. Additionally or alternatively, the processor 310 may generate messages based on deterministic algorithms. Using the same example, the message “RFID: XXXXXXXXX (box of medications) found in Area 1 instead of Area 2” may be generated by following a deterministic algorithm, namely “RFID: [RFID]” ([description]) found in [actual location] instead of [correct location].”

In some embodiments, the processor 310 may generate messages using generative artificial intelligence. For example, the message “Firearm carrying person detected in Aisle 4” may be generated using generative artificial intelligence.

In some embodiments, the processor 310 may generate audio messages. In other embodiments, the processor 310 may generate text or string messages. In some embodiments, the processor 310 may transmit video data. For example, the processor 310 may transmit a sample video clip from camera footage showing an armed individual in a particular aisle in a store.

In some embodiments, the processor 310 may interpret responses received from the security personnel. For example, after sending the message “Firearm carrying person detected in Aisle 4,” the computer system 100 or the processor 310 may receive from a PTT device of a security guard “Follow.” The processor 310 may interpret “Follow,” to mean that the security camera would like the cameras of the building to follow the firearm carrying person.

In some embodiments, the processor 310 may receive pre-defined messages or commands over a PTT network. For example, “Follow” may be a pre-defined command. In some embodiments, the processor 310 may use artificial intelligence such as a large language model to interpret messages received over the PTT network. For example, after sending the message “Firearm carrying person detected in Aisle 4,” the computer system 100 or the processor 310 may receive from a PTT device of a security guard “Is he moving?” The processor 310 may use a large language model to interpret the received message. Further, the processor 310 may use the large language model to generate a reply message in response to the received message. For example, in response to receiving “Is he moving?” from a PTT device, the processor 310 analyze security camera images and video and generate a reply message “He is moving down Aisle 4 toward the candy section.”

The action module 318 allows the processor 310 to affect physical systems related to the monitored environment such as building systems. In some embodiments, the processor 310 or the computer system 100 may interact with a sensor system of a building such as the sensor system 122A (see FIG. 1A). For example, in response to receiving the message “Follow” from a PTT device, the processor 310 or computer system 100 may manipulate the positioning or angle of security cameras in the building to track a firearm carrying person.

In some embodiments, the processor 310 or computer system 100 may interact with a door system of a building such as the door system 124A (see FIG. 1A). For example, in response to receiving the message “Trap,” the processor 310 or computer system 100 may cause some of the doors in the building to close and lock, thereby trapping a firearm carrying individual in an enclosed space. In another example, in response to receiving the message “Evacuate,” the processor 310 or computer system 100 may cause some of the doors in the building to remain perpetually open, thereby allowing for a quick evacuation out of the building.

In some embodiments, the processor 310 or computer system 100 may interact with a lighting system of a building such as the lighting system 126A (see FIG. 1A). For example, in response to receiving the message “Trap,” the processor 310 or computer system 100 may cause some of the doors in the building to lock and some of the lights in the building to turn off, thereby trapping a firearm carrying individual in a dark enclosed space. In another example, in response to receiving the message “Path,” the processor 310 or computer system 100 may cause some of the lights in the building to turn on, thereby showing a path for security personnel to follow to a detected security threat or alert condition.

In some embodiments, the processor 310 or computer system 100 may interact with an HVAC system of the building such as the HVAC system 128A (see FIG. 1A). For example, in response to receiving the message “Cool,” the processor 310 or computer system 100 may cause a temperature-controlling system to lower the temperature in an overheated room of the building. In another example, in response to receiving the message “Filter” or “Clean,” the processor 310 or computer system 100 may cause an air quality controlling system to remove toxic particles from the air of a particular room.

In some embodiments, the processor 310 or computer system 100 may interact with an alarm system such as the alarm system 130A (see FIG. 1A). For example, in response to receiving the message “Sound alarm,” the processor 310 or computer system 100 may cause an alarm to be activated.

FIG. 3 shows the computer system 100 including network hardware 340. The network hardware includes at least one at least one network interface 342 and a PTT radio gateway 344. The network hardware 340 facilitates wired or wireless communication with an external system or network (e.g., a PTT network, cellular, an intranet, the Internet, a P2P network, a WAN, a LAN), and in particular, facilitates communication with a PTT device such as the PTT device 110 or 110A (see FIGS. 1 and 1A) and communication with a monitoring system such as the monitoring system 120 or systems related to the building 120A (see FIGS. 1 and 1A). In some embodiments, the computer system 100 may be able to wireless communicate with the PTT device over a PTT network such as the at least one PTT network 150 or 150A (see FIGS. 1 and 1A). In some embodiments, the computer system 100 may operate in a transmission mode or a reception mode. When in transmission mode, the computer system 100 may transmit messages or data over the PTT network. When in reception mode, the computer system 100 may receive messages or data over the PTT network. In some embodiments, the PTT device may only transmit messages or data over the PTT network when in transmission mode.

The PTT radio gateway 344 facilitates wired or wireless communication over a variety of PTT networks or PTT radio networks. For example, the computer system 100 may be connected to PTT devices held by personnel of a first security group via a first PTT network while simultaneously being connected to PTT devices held by personnel of a second security group via a second PTT network. The computer system 100 may transmit and receive messages specific to the first security group over the first PTT network and transmit and receive messages specific to the second security group over the second PTT network.

In some embodiments, messages transmitted or received over the PTT network may have an associated priority level. In the event that, the computer system 100 receives multiple messages over the PTT network, the computer system 100 may cause the message with the higher associated priority level to override the message with the lower priority level. That is, the computer system 100 receives the message with the higher priority level.

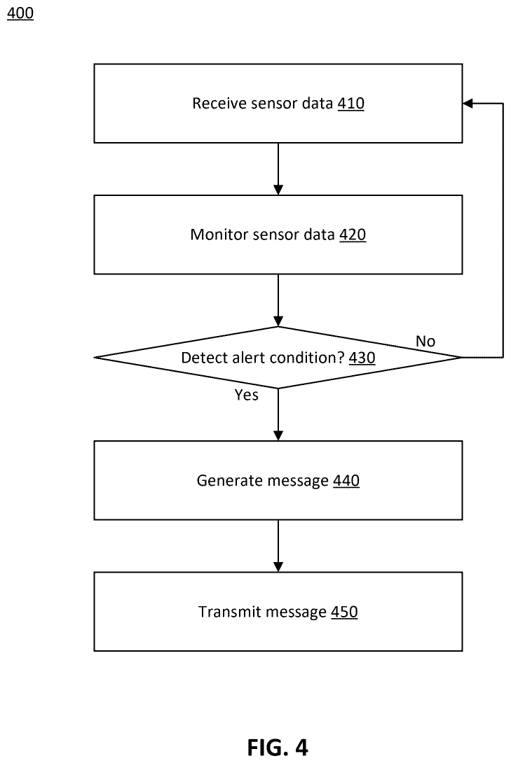

Reference is now made to FIG. 4 which shows in flowchart form, a method 400 allowing for generation of automated security alerts with respect to a monitored environment. The method 400 may be performed by a computer system that supports a safety, security, or risk management system of a monitored environment such as the computer system 100 as shown in FIG. 3. The computer system may be connected to a PTT radio network or PTT network and comprise a PTT radio gateway and a processor coupled to the PTT radio gateway. In particular, the computer system may have a memory storing computer executable instructions for the processor to execute operations of the method 400.

The method 400 begins with an operation 410. At the operation 410, a processor may receive sensor data from at least one sensor deployed on or within the monitored environment such as a monitored kitchen, a monitored laboratory, or a building. The sensor data may include image and video data from cameras, audio data from audio recorders, temperature or heat data from heat sensors or temperature sensors, moisture data from moisture sensors, pressure data from pressure or touch sensors, lighting data from light sensors, chemical data from smoke sensors or other chemical sensors such as air quality sensors, motion data from motion sensors, EAS data from EAS sensors, RFID data from RFID readers, and BLE data from BLE gateways. In some embodiments, the at least one sensor may include a wearable sensor situated on a person.

In some embodiments, the processor may also receive data from building systems or databases. For example, the processor may, from a door system of a building, receive data relating to the states of the doors in the building. For example, each door in the building may be in one of four states: open & idle, open & opening, open & closing, and closed. In another example, the processor may, from a lighting system, receive data relating to the states of the lights in the building. For example, each light in the building may have a state defined by a numeric value representing its brightness. Additionally or alternatively, each light in the building may have a state defined by a first value representing brightness and a second value representing color. In another example, the processor may, from an alarm system of the building, receive data relating to the states of alarms in the building. For example, each alarm in the building may be in a state defined by an activation variable (e.g. 0 for off and 1 for on), a defectiveness variable (e.g. 0 for not defective, 1 for detective such as in the situation when the alarm should be on but is not), and a trigger source variable (corresponding to how the alarm was turned on if it is on). In another example, the processor may, from a POS device system, receive data relating to sales that have occurred in the building such as user ID of a POS device in relation to a particular sale of a product. In another example, the processor may, from a database, receive data relating to inventory.

After the operation 410, flow control proceeds to an operation 420. At the operation 420, the processor may monitor the received data, including sensor data, for an alert condition or a security threat. While FIG. 4 shows the operation 410 and the operation 420 in sequence, in some embodiments, the operation 410 and the operation 420 may be executed simultaneously.

That is, the processor may receive and monitor data simultaneously.

After the operation 420, flow control proceeds to a decision 430. At the decision 430, the processor may detect an alert condition or a security threat.

In some embodiments, the processor may detect an alert condition based on the sensor data. Further, in some embodiments, the at least one sensor includes a camera and the alert condition is based, at least in part, on identifying a threat depicted in one or more images generated by the camera. For example, the processor may use video analytics to detect that a vehicle entering a restricted zone does not have an authorized license number. In another example, the processor may use facial recognition technology on an image to determine that an unauthorized person is carrying a firearm.

In some embodiments, the processor may track, using at least one of the sensors, one or more assets within a building and the alert condition may correspond to one of the one or more assets exiting an authorized zone. For example, the processor may receive data from an EAS sensor indicating that an EAS-tagged item has been removed from a location without deactivation of the EAS tag. In another example, the processor may receive data from an RFID reader (sensor) indicating that a RFID-tagged item is not present in an expected location for that item. In another example, the processor may receive data from a BLE gateway (sensor) indicating that a BLE-tagged item has been removed from the premises of a store. Likewise, using EAS, RFID, or BLE technology, the processor may track one or more assets within the building and the alert condition may correspond to an unauthorized translation of one of the one or more assets.

In some embodiments, the processor may obtain an inventory record from a storage such as a database and track, using sensors such RFID readers, one or more assets within a building. The alert condition may correspond to an inconsistency of the inventory record and the one or more assets being tracked.

In some embodiments, the processor may obtain POS data from a POS device system and the alert condition may be an anomaly in POS data. For example, the processor may detect that inventory levels, obtained from a database, are inconsistent with sales data. In another example, the processor may detect an anomaly in sales data such as voiding of transactions and no-sale events.

In some embodiments, the processor may analyze obtained data in real-time. In other embodiments, the processor may analyze past data that has been stored in, for example, a database. For example, the processor may detect alert conditions by comparing data relating to the building in “safe” periods of the past to current data.

In some embodiments, the processor may detect alert conditions based on pre-defined conditions or determinations. For example, the processor may determine that an EAS sensor detecting removal of a tagged item without deactivation, by itself, is a security threat or an alert condition. In another example, the processor may determine that an inconsistency between inventory and sales data that exceeds a defined threshold is an alert condition.

In some embodiments, the processor may use artificial intelligence or machine learning algorithms to detect alert conditions. For example, the processor may be configured to detect an alert condition by using artificial intelligence to analyze the sensor data. The processor may also, using machine learning, detect features of the security threat or alert condition. For example, in the event that the processor detects an unauthorized person carrying a firearm, the processor may also detect that the firearm holder is wearing a shirt of a particular color and a particular brand, is of a particular sex, is of a particular height, has a particular movement pattern (e.g. a limp), has a particular hair color, etc. In another example, machine learning may be used to detect behavior predictive of a security threat from camera footage. For example, the processor may detect abnormal or suspicious loitering of an individual. In another example, machine learning may be used to detect anomalies in POS data.

In some embodiments, the processor may be configured to detect the location of the alert condition. For example, the processor may receive RFID data indicating that an item with an RFID is in an unauthorized location or zone for that item. In another embodiment, the processor 310 may detect location using artificial intelligence such as machine learning or video analytics. For example, the processor may determine from images from a camera that a theft is occurring at a particular aisle in a retail store.

If an alert condition is detected at the decision 430, flow control proceeds to an operation 440. At the operation 440, the processor may generate, in response to the alert condition, a message corresponding to the alert condition. For example, in response to detecting an unauthorized person with a firearm in, for example, aisle 4 of a store, the processor may generate the message “Firearm carrying person detected in Aisle 4.” In another example, in response to detecting that an RFID-tagged item is in an incorrect Area 1 instead of a correct Area 2, the processor 310 may generate the message “RFID: XXXXXXXXX (box of medications) located in Area 1 instead of Area 2.”

In some embodiments, the message may be pre-defined. For example, the message “RFID: XXXXXXXXX (box of medications) located in Area 1 instead of Area 2” may be a pre-defined message for the appropriate situation. Additionally or alternatively, the processor may generate messages based on deterministic algorithms. Using the same example, the message “RFID: XXXXXXXXX (box of medications) located in Area 1 instead of Area 2” may be generated by following a deterministic algorithm, namely “RFID: [RFID]” ([description]) found in [actual location] instead of [correct location].”

In some embodiments, the processor may generate messages using generative artificial intelligence deterministic algorithms. Additionally or alternatively, the processor may be configured to use a large language model to generate messages corresponding to alert conditions. For example, the message “Firearm carrying person detected in Aisle 4” may be generated using generative artificial intelligence or a large language model.

After the operation 440, flow control proceeds to an operation 450. At the operation 450, the processor may interface with the PTT radio gateway to transmit the message over the PTT network to a PTT device. In some embodiments, the processor may record the message, the PTT network the message was transmitted over, the time and date of the transmission, or a combination thereof in a storage or database for recordkeeping.

In some embodiments, after transmitting the message over the PTT network, the processor may wait for or measure time until it receives a response message or a confirmation from the PTT device. If a response message or confirmation is not received within a certain amount of time, the processor may retransmit the message. If the processor repeatedly fails to receive a response message or confirmation, the processor may consider that another alert condition has been detected and, in a sense, return to the operation 440 for a new alert condition.

If an alert condition is not detected at the decision 430, flow control proceed, or returns, to the operation 410. That is, the processor continues to receive and monitor data related to the monitored environment, including sensor data.

In some embodiments, the processor may transmit the message as an audio message. In other embodiments, the processor may transmit the message as a text message. In some embodiments, the processor may transmit video data along with the message to the PTT device. For example, the sensor data may include video data showing an armed individual in a particular aisle of a retail store. The processor may transmit a sample of the video data selected to represent the alert condition to the PTT device along with the message.

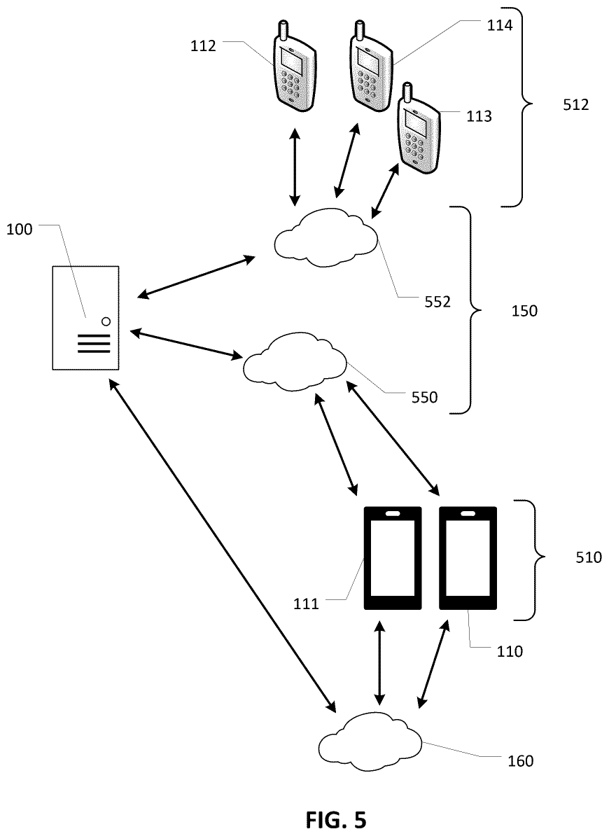

Reference is now made to FIG. 5 which shows a computer system 100 (see FIG. 1) in communication with multiple groups of PTT devices over different PTT networks or PTT radio networks. As shown in FIG. 5, at least one PTT network or PTT radio network 150 (see FIG. 1) connects the computer system 100 to a first plurality or group of PTT devices 510 and a second plurality or group of PTT devices 512. The at least one PTT network 150 includes a first PTT network or PTT radio network 550 and a second PTT network or PTT radio network 552. The first PTT network 550 connects the computer system 100 to a the first plurality of PTT devices 510 and the second PTT network 552 connects the computer system 100 to the second plurality of PTT devices 512. The first plurality of PTT devices 510 includes a PTT device 110 (see FIG. 1) and a PTT device 111. The second plurality of PTT devices 512 includes a PTT device 112 (see FIG. 1), a PTT device 113, and a PTT device 114. FIG. 5 also shows a wireless network 160, separate from the first PTT network 550 and the second PTT network 552, connecting the computer system 100 to the first plurality of PTT devices 510. The wireless network 160 may be a cellular network such as a WiFi network, a LAN, a WAN, a 5G network, or a combination thereof.

In some embodiments, the first plurality of PTT devices 510 may be held by a first group or team of security personnel and the second plurality of PTT devices 512 may be held by a second group or team of security personnel. For example, the first plurality of PTT devices 510 may belong to the security team of a first terminal of an airport while the second plurality of PTT devices 512 may belong to the security team of a second terminal of an airport. In this example, the computer system 100 may transmit notifications or alerts specific to the security team of the first terminal via the first PTT network 550 and transmit notifications or alerts specific to the security team of the second terminal via the second PTT network 552.

In some embodiments, the computer system 100 may use the wireless network 160 to override PTT network transmissions from other systems or devices. For example, the computer system 100 may detect an urgent security threat or alert condition that the computer system determines is a priority for users of the first plurality of PTT devices 510 to be aware of. In this example, the computer system 100 may transmit instructions over the wireless network 160 to the first plurality of PTT devices 510 wherein the instructions cause the first plurality of PTT devices 510 to be in a reception mode. Following the transmission of instructions, the computer system 100 may then transmit a message corresponding to the alert condition to the first plurality of PTT devices 510 via the first PTT network 550.

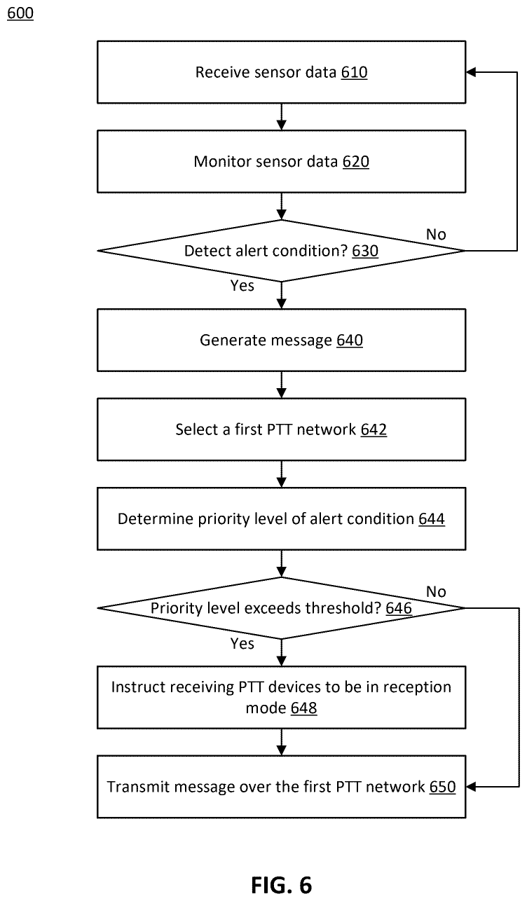

Reference is now made to FIG. 6 which shows, in flowchart form, a method 600 allowing for generation of automated security alerts with respect to a monitored environment. The method 600 may be performed by a computer system that supports a safety, security, or risk management system of a monitored environment such as the computer system 100 as shown in FIGS. 1, 3 and 5 or the computer system 100A as shown in FIG. 1A. The computer system may be connected to multiple PTT radio networks or PTT networks and comprise a PTT radio gateway and a processor coupled to the PTT radio gateway. The computer system may also be connected to other wireless networks such as the wireless network 160 as shown in FIGS. 1 and 5 or the wireless network 160A as shown in FIG. 1A. In particular, the computer system may have a memory storing computer executable instructions for the processor to execute operations of the method 600.

The method 600 begins with an operation 610 followed by an operation 620, a decision 630, and an operation 640. The operations and decision include receiving data related to the building including sensor data from the building, monitoring the received data including the sensor data, detecting an alert condition or security threat from the monitored data, and generating a message corresponding to the alert condition in response to detecting the alert condition. The operation 610, the operation 620, the decision 630, and the operation 640 parallel or are similar to the operation 410, the operation 420, the decision 430, and the operation 440 of the method 400 (see FIG. 4).

After the operation 640, control flow may proceed to an operation 642. At the operation 642, the processor may select a first PTT network or at least one of the multiple PTT networks connected to the computer system. In some embodiments, the processor may select the first PTT network in response to determining that the detected alert condition is relevant to the users of or security personnel carrying PTT devices wireless connected to the computer system via the first PTT network. In some embodiments, there may be a mapping between alert conditions and the multiple PTT networks. In other embodiments, there may be mapping between alert conditions and the users of or the pluralities of users of the multiple PTT networks. For example, a first type of alert condition may be mapped to the first PTT network and a second type of alert condition may be mapped to a second PTT network. That is, the processor detects the first type of alert condition, the processor selects the first PTT network and the processor detects the second type of alert condition, the processor selects the second PTT network.

After the operation 642, control flow may proceed to an operation 644. At the operation 644, the processor determines a priority level of the detected alert condition. For example, if the alert condition is an unauthorized person carrying a firearm, the priority level may be a value indicating a high priority. In another example, if the alert condition is suspicious loitering, the priority level may be a value indicating a lower priority. In some embodiments, the priority level may be binary. For example, the priority level may be one of “normal” and “urgent.” In another example, the priority level may be one of 0 and 1. In some embodiments, the priority level may be one of multiple values. For example, the priority level may be one of the integers between 1 and 5 inclusive. In some embodiments, the priority level may be determined from a spectrum of values. For example, the priority level may be a real number between 0 and 1.

After the operation 644, flow control may proceed to a decision 646. At the decision 646, the processor determines if the priority exceeds a threshold. The threshold may be considered a standard or level of urgency where, if surpassed, a communication or transmission over a PTT network from the computer system should be prioritized over other communications or transmissions over the same PTT network from other devices. In the example where the priority level is binary (0 or 1), the threshold may be 0. In the example where the priority level is one of “normal” and “urgent,” the threshold may be “normal” and “urgent” may be considered to exceed “normal.” In the example where the priority level is a real number between 0 and 1, the threshold may be 0.5.

If the processor determines at the decision 646 that the priority level exceeds the threshold, flow control proceeds to an operation 648. At the operation 648, the processor instructs the PTT devices that will receive the generated message, or the PTT devices connected to the selected PTT network, to enter a reception mode. In some embodiments, the processor may instruct the receiving PTT devices by transmitting mode instructions to the PTT devices via a separate wireless network, wherein receiving the mode instructions via the separate wireless network causes the PTT devices to be in a reception mode. When in the reception mode, the PTT devices may not initiate any transmissions over the PTT network they are connected to or the PTT network they are in reception mode for. Hence, instructing PTT devices to be in a reception mode may lower the risk of interference with transmission of the generated message from the computer system in the event that the alert condition is urgent or has high priority.

After the operation 648, flow control may proceed to an operation 650. At the operation 650, the processor may interface with the PTT radio gateway to transmit the message over the PTT network selected in the operation 642. In the event that a first PTT network was selected in the operation 642, the generated message is transmitted over the first PTT network. In some embodiments, the processor may record the message, the PTT network the message was transmitted over, the time and date of the transmission, or a combination thereof in a storage or database for recordkeeping.

In some embodiments, after transmitting the message over the first PTT network, the processor may wait for or measure time until it receives a response message or a confirmation from a PTT device that received the transmission. If a response message or confirmation is not received within a certain amount of time, the processor may retransmit the message over the same PTT network. If the processor repeatedly fails to receive a response message or confirmation, the processor may consider that another alert condition has been detected and, in a sense, return to the operation 640 for a new alert condition.

If the processor determines at the decision 646 that the priority level does not exceed the threshold, flow control may directly proceed to the operation 650. Since, in this scenario, the PTT devices receiving the generated message are not instructed to be in a reception mode, one of the receiving PTT devices being in a transmission mode may interfere with the transmission of the message from the computer system.

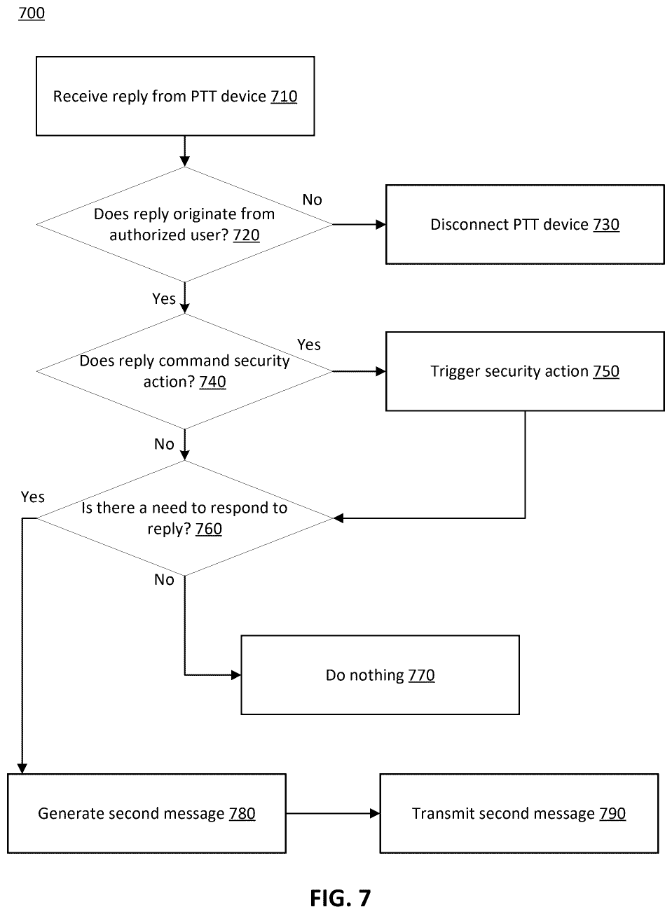

Reference is now made to FIG. 7 which shows, in flowchart form, a method 700 allowing a computer system to receive messages from PTT devices and affect a security system of a building such as the building 120A (see FIG. 1A). The method 700 may be performed by a computer system that supports a security system of a building such as the computer system 100A (see FIG. 1A). The computer system may be connected to a PTT radio network or PTT network and comprise a PTT radio gateway and a processor coupled to the PTT radio gateway. The computer system may also be connected to the building or building systems such as a sensor system via a separate wireless network such as the wireless network 160A (see FIG. 1A). The wireless network may also connect the computer system to PTT devices along with the PTT network. In particular, the computer system may have a memory storing computer executable instructions for the processor to execute operations of the method 700.

The method 700 may be executed after the computer system has already transmitted a message corresponding to an alert condition or a security alert over a PTT network to a PTT device. The method 700 may be executed by the computer system after the same computer system execute the method 400 (see FIG. 4) or the method 600 (see FIG. 6).

The method 700 begins with an operation 710. At the operation 710, the computer system or processor receives a reply or reply message from a PTT device over the PTT network. The reply may be an audio message.

After the operation 710, control flow proceeds to the decision 720. At the decision 720, the computer system or processor determines if the reply originates from an authorized user of the PTT device. The processor may determine that the reply originates from an authorized user by identifying a voice signature in the reply. The processer may then determine that the voice signature belongs to a first authorized user. That is, the processor may determine that an authorized user or a first authorized user is an owner of the identified voice signature. In some embodiments, the computer system or processor may obtain, from a storage such as a database, data representing voice signatures of one or more authorized users of the PTT device. The processor may compare these voice signatures to the voice signature identified from the reply.

If the processor determines that the reply does not originate from an authorized user at the decision 720, control flow proceeds to an operation 730. At the operation 730, the processor may cause the PTT device to be disconnected from the PTT network. In some embodiments, the processor may transmit disconnection instructions to the PTT device via the separate wireless network wherein the disconnection instructions unilaterally cause the PTT device to disconnect from the PTT network. The disconnection instructions may further cause the PTT device to disconnect from any communication network that is shares with the computer system including the separate wireless network.

If the processor determines that the reply originates from an authorized user at the decision 720, flow control may proceed to a decision 740. At the decision 740, the processor determines if the reply contains a security action. That is, the processor determines if the reply contains a command to initiate a security action. A command to initiate a security action may be a reply such as “Follow” in response to an earlier message from the computer system such as “Firearm carrying person detected in Aisle 4.” In some embodiments, the commands for the security actions may be pre-defined. For example, “Follow” may be a pre-defined command to have security cameras follow a person or target. In some embodiments, artificial intelligence such as machine learning or large language models may be used to identify a command in the reply. For example, a large language model may be used to identify pre-defined commands. In another example, a large language model may be used to identify commands that are not pre-defined. For example, the processor may use a large language model to determine that the reply “What does he look like?” indicates that the user of the PTT device from which the reply originates would like a description of a person or target identified a alert condition or security threat. That is, the processor may interpret “What does he look like?” as the command “Describe” or consider “What does he look like?” to contain the command “Describe.”

If the processor identifies a command to initiate a security action in the decision 740, flow control proceeds to an operation 750. At the operation 750, the processor triggers a security action in response to identify the command to initiate the security action.

In some embodiments, the security action may include interacting with the sensor system of the building via wireless communication over the wireless network. For example, upon receiving the command “Follow,” the computer system may manipulate the positioning, angles, or zoom controls of security cameras of the building to follow or track a person or target. That is, the security action may include manipulating a security cameras. In another example, the security action may include recording image or video data from security cameras in response to the command “Record.”

In some embodiments, the security action may include interacting with a door system of the building via wireless communication over the wireless network. For example, in response to receiving the message “Trap,” the processor or computer system may cause some of the doors in the building to close and lock, thereby trapping a firearm carrying individual in an enclosed space. In another example, in response to receiving the message “Evacuate,” the processor or computer system may cause some of the doors in the building to remain perpetually open, thereby allowing for a quick evacuation out of the building. That is, the security action may include manipulating a door.

In some embodiments, the security action may include turning lights on or off. Additionally or alternatively, the security action may include interacting with a lighting system of the building. For example, in response to receiving the message “Trap,” the processor or computer system may cause some of the doors in the building to lock and some of the lights in the building to turn off, thereby trapping a firearm carrying individual in a dark enclosed space. In another example, in response to receiving the message “Path,” the processor or computer system may cause some of the lights in the building to turn on, thereby showing a path for security personnel to follow to a detected security threat or alert condition. In another example, the security action may turn on warning lights in the building.

In some embodiments, the security action may include interacting with an HVAC system of the building. For example, in response to receiving the message “Cool,” the processor or computer system may cause a temperature-controlling system to lower the temperature in an overheated room of the building. In another example, in response to receiving the message “Filter” or “Clean,” the processor or computer system may cause an air quality controlling system to remove toxic particles from the air of a particular room.

In some embodiments, the security action may include triggering an alarm or siren in the building. For example, in response to receiving the message “Sound alarm,” the processor or computer system may cause an alarm to be activated.

In some embodiments, the security action may include dispatching security personnel of the building to a particular location or target location. For example, in response to receiving the message “Send team,” the processor or computer system may broadcast over the PTT network, the wireless network, or another network, a message to a response team to a first, target, or specific location related to the alert condition.

Following the operation 750, flow control proceeds to the decision 760. Likewise, if the processor determines that the reply does not contain a command to initiate or trigger or security action at the decision 740, flow control proceeds to the decision 760. At the decision 760, the processor determines if there is a need to send a response message to the reply. In some embodiments, the reply may contain a query. For example, the reply may be the message “Is the suspect moving?” The computer system or processor may identify the query and determine that a second message should be transmitted to the PTT device from which the reply originates.

If the computer system or processor determines at the decision 760 that there is no need to send another message to the PTT device from which the reply originates, flow control proceeds to the operation 770. At the operation 770, the processor does nothing, or rather, the method 700 may be considered terminated. After executing or reaching the operation 770, the processor may execute the method 700 again or execute another method such as the method 400 (see FIG. 4). In some embodiments, the method 400, or alternatively the method 600 (FIG. 6), may be executed simultaneously with the method 700. In some embodiments, multiple instances of the method 700 may execute simultaneously. For example, the method 700 may execute for an alert condition corresponding to a suspicious car in a parking lot and an alert condition corresponding to a loss of power in a particular room of the building.

If the computer system or processor determines at the decision 760 that there is a need to send a second message to the PTT device from which the reply originates, flow control proceeds to an operation 780. At the operation 780, the processor generates a second message.

In some embodiments, the computer system or processor may determine, in response to identifying a query in the reply, an answer to the query. In some embodiments, the answer may be determined based on data received from the building including sensor data. For example, the computer system or processor may receive from the PTT device the reply “Is the suspect moving?” The processor may use a large language model to interpret the reply. Further, the computer system or processor may determine based on security camera footage that the suspect is moving down an Aisle 4 toward a candy section. That is, the answer determined by the computer system or process is that the suspect is moving down an Aisle 4 toward a candy section.

In some embodiments, in response to determining the answer to a query, the computer system or processor may generate a second message corresponding to the answer. For example, the processor may use a large language model to generate the message “He is moving down Aisle 4 toward the candy section.” In some embodiments, determining the answer to a query and generating the second message may be completed at once via the use of machine learning. For example, a machine learning model or a large language model may be inputted with the reply and sensor data and then output a message such as “He is moving down Aisle 4 toward the candy section.”

After the operation 780, flow control may proceed to an operation 790. At the operation 790, the computer system or processor transmits the second message generated at the operation 780 over the PTT network, thereby resulting in the PTT device receiving the second message. In some embodiments, the processor may record the message, the PTT network the message was transmitted over, the time and date of the transmission, or a combination thereof in a storage or database for recordkeeping.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer system for monitoring a monitored environment, the computer system being connected to at least one push-to-talk radio network, and comprising:
network hardware including a push-to-talk radio gateway;
a processor coupled to the push-to-talk radio gateway and at least one sensor;
a memory coupled to the processor, the memory storing instructions that, when executed, cause the processor to:
receive sensor data from at least one sensor deployed in the monitored environment;
detect, based on the sensor data, an alert condition;
generate, in response to the alert condition, a message corresponding to the alert condition; and
interface with the push-to-talk radio gateway to transmit the message over the at least one push-to-talk radio network to a push-to-talk device.

2. The computer system of claim 1 wherein the at least one sensor includes a camera and the alert condition is detected based, at least in part, on identifying a threat depicted in one or more images generated by the camera.

3. The computer system of claim 1 wherein the computer system is configured to detect the alert condition by using artificial intelligence to analyze the sensor data.

4. The computer system of claim 1 wherein the computer system is configured to use a large language model to generate the message.

5. The computer system of claim 1 wherein the computer system is connected to a wireless network and is further configured to:
determine a priority level of the alert condition; and
determine that the priority level exceeds a threshold; and
transmit via the wireless network, prior to interfacing with the push-to-talk radio gateway, in response to determining that the priority level exceeds the threshold, mode instructions to the push-to-talk device, the mode instructions causing the push-to-talk device to be in a reception mode.

6. The computer system of claim 1 wherein:
the at least one push-to-talk radio network includes multiple push-to-talk networks;
the push-to-talk device is connected to a first push-to-talk network of the multiple push-to-talk networks;
the instructions further configure the computer system to:
determine, prior to interfacing with the push-to-talk radio gateway, that the alert condition is relevant to a user of the push-to-talk device; and
select the first push-to-talk network in response to determining that the alert condition is relevant to the user; and
interfacing with the push-to-talk radio gateway to transmit the message over the at least one push-to-talk radio network further comprises transmitting the message over the first push-to-talk network.

7. The computer system of claim 1 wherein the at least one sensor includes a wearable sensor situated on a person.

8. The computer system of claim 1 wherein the instructions further configure the computer system to:
receive a reply from the push-to-talk device;
identify, in the reply, a voice signature;
determine that an authorized user is an owner of the voice signature;
identify, in the reply, a command to initiate a security action; and
trigger, in response to identifying the command to initiate the security action, the security action.

9. The computer system of claim 8 wherein the security action includes manipulating a security camera.

10. The computer system of claim 8 wherein the instructions further configure the computer system to:
identify, in the reply, a query;
determine, in response to the query, an answer to the query based on the sensor data;
generate, in response to determining the answer, a second message corresponding to the answer; and
transmit the second message to the push-to-talk device.

11. The computer system of claim 1 wherein:
the sensor data includes video data, and wherein the instructions further configure the processor to:
transmit a sample of the video data selected to represent the alert condition to the push-to-talk device.

12. The computer system of claim 1 wherein the instructions further configure the computer system to track, using the at least one sensor, one or more assets within the monitored environment, and the alert condition corresponds to one of the one or more assets exiting an authorized zone.

13. The computer system of claim 1 wherein the instructions further configure the computer system to:
maintain an inventory record; and
track, using the at least one sensor, one or more assets within the monitored environment, and the alert condition corresponds to an inconsistency of the inventory record and the one or more assets.

14. The computer system of claim 1 wherein the instructions further configure the computer system to track, using the at least one sensor, one or more assets within the monitored environment, and the alert condition corresponds to an unauthorized translation of one of the one or more assets.

15. The computer system of claim 1 wherein the instructions further configure the computer system to obtain point-of-sale data from a point-of-sale device system, and the alert condition is an anomaly in the point-of-sale data.

16. The computer system of claim 1 wherein the push-to-talk device is a wearable device.

17. A computer-implemented method for monitoring a monitored environment, the method comprising:
receiving sensor data from at least one sensor deployed in the monitored environment;
detecting, based on the sensor data, an alert condition;
generating, in response to the alert condition, a message corresponding to the alert condition; and
interfacing with a push-to-talk radio gateway to transmit the message over at least one push-to-talk radio network to a push-to-talk device.

18. The computer-implemented method of claim 17 further comprising:
determining a priority level of the alert condition;
determining that the priority level exceeds a threshold; and
transmitting via a wireless network, prior to interfacing with the push-to-talk radio gateway, in response to determining that the priority level exceeds the threshold, mode instructions to the push-to-talk device, the mode instructions causing the push-to-talk device to be in a reception mode.

19. The computer-implemented method of claim 17 wherein:
the at least one push-to-talk radio network includes multiple push-to-talk networks;
the push-to-talk device is connected to a first push-to-talk network of the multiple push-to-talk networks;
the method further comprises:
determining, prior to interfacing with the push-to-talk radio gateway, that the alert condition is relevant to a user of the push-to-talk device; and
selecting the first push-to-talk network in response to determining that the alert condition is relevant to the user; and
interfacing with the push-to-talk radio gateway to transmit the message over the at least one push-to-talk radio network further comprises transmitting the message over the first push-to-talk network.

20. The computer-implemented method of claim 17 further comprising:
receiving a reply from the push-to-talk device;
identifying, in the reply, a voice signature;
determining that an authorized user is an owner of the voice signature;
identifying, in the reply, a command to initiate a security action; and
triggering, in response to identifying the command to initiate the security action, the security action.
